(19) United States
(12) Patent Application Publication
(10) Pub. No.: US 2003/0227454 A1
(43) Pub. Date: Dec. 11, 2003

(54) Process and computer system for generating a multidimensional offset surface

(76) Inventors: Hermann Kellermann, Reutlingen (DE); Jens Olav Nygaard, Oslo (DE)

Correspondence Address: SHLESINGER, ARKWRIGHT & GARVEY LLP, 3000 SOUTH EADS STREET, ARLINGTON, VA, 22202, US

(21) Appl. No.: 10/441,287

(22) Filed: May 20, 2003

(30) Foreign Application Priority Data
Jun. 7, 2002 (DE) 102 26 270.5

(51) Int. Cl. G06F 19/00

(52) U.S. Cl. 345/420; 700/187

(57) ABSTRACT

Process for generating a multidimensional offset surface with a predeterminable distance (d) from a starting surface (10, 20) of the same dimensions, wherein in order to generate a point on the offset surface (10″) (offset point) an approximation normal (N_{D}) is determined, which stands perpendicular to an approximation surface the position and course of which correspond approximately to the position and course of the starting surface (10, 20), the approximation normal (N_{D}) forming a point of intersection (S₃) with the starting surface (10, 20) which forms the point of the starting surface (10, 20) relative to which the associated offset point is to be generated, and the offset point is generated along the direction of the approximation normal (N_{D}) starting from the point of intersection (S₃) at a distance corresponding to the given offset distance (d), while a plurality of offset points obtained in this way serve to form the offset surface (10″).

### FIELD OF THE INVENTION

The present invention relates to a (computer-aided) process and a computer system for generating an n-dimensional offset surface where n is a natural number>1. In particular, the present invention relates to the computer-aided or computer-implemented generation of two-dimensional offset curves and three-dimensional offset surfaces in CAD/CAM.

### DESCRIPTION OF THE RELATED ART

In the interests of simplicity the description that follows will refer throughout to the two-dimensional case, i.e. an offset curve, by way of example, to represent multidimensional surfaces in general.

An offset curve is a curve which has essentially the same shape as a first curve but is offset from this first curve by a certain distance d. This does not necessarily mean a copy of the first curve displaced by a distance d but rather an accumulation of all the points which are at a spacing d from the points of the first curve in the direction of the normal of the first curve at the corresponding point. Or in other words: an offset surface is defined as the collection of points wherein each point is at a constant distance d from a corresponding point on the starting surface in the direction of the normal vector. In mathematical terms the offset curve C_{d}(t) of a parameter curve C(t)=(x(t), y(t)) is given by

C_{d}(t)=C(t)+dN_{T}(t) (1)

wherein d is the offset distance and N_{T}(t) is the unified normal vector of C(t), i.e. the normal on the tangent T at point t. An overview of offset curves is provided, for example, by Binh Pham in “Offset Curves and Surfaces: A Brief Survey”, Computer Aided Design 24 (1992), pages 223 to 229.

Offset surfaces and curves occur in numerous industrial applications, e.g. in planning robot paths and generating tool paths for digital control in industrial production. Normally, representation is carried out in parametric form as the parameters represent a direct association between a curve and its “offset” (i.e. the associated offset curve).

The generation of offset curves and surfaces is not a simple undertaking for a number of reasons. Thus, for example, there may be no clear offset because there is more than one normal direction at a given point on the starting curve (thus, for example, at points of tangential discontinuity corresponding to an inconsistency in the second derivative). The shape of the offset curve depends not only on the shape of the starting curve but also on the offset distance, the alignment and also the local curvature. If the starting curve is represented by so called splines, the offset curve obtained is generally not a spline. Splines are used in order to approximate complex curves and surfaces in CAD design and may have some points of inconsistency in their second derivatives. There is no need to go any further into the theory underlying splines at this point as it is well known to those skilled in the art. Purely by way of example we refer here to DE 100 23 377 A1 and to “A Practical Guide to Splines” by C. de Boor, published by Springer, 1978.

One of the problems when generating offset curves is that the evenness/smoothness and interface properties of the first curve (starting curve) are not necessarily transferred. Thus, for example, a totally smooth starting curve at a given offset value may have a non-smooth offset curve which bisects itself. This problem is illustrated by way of example in FIG. 1.

To overcome the disadvantages in the generation of offset curves numerous methods of approximation have already been proposed in the prior art (cf the article by Binh Pham mentioned above and also Gershon Elber et al in “Comparing Offset Curve Approximation Methods”, IEEE Computer Graphics and Applications, 1997, pages 62 to 71. Most of the known methods use iterative techniques to generate an approximation curve the accuracy of which is measured and if the tolerance is exceeded in a subdivided area, the error is removed by further approximation.

### SUMMARY OF THE INVENTION

Starting from this, the problem on which the invention is based is to provide a process by which offset curves are generated, in the field of computer-aided curve and surface generation, which do not bisect themselves, wherein the difference between the distance of a point on the given starting surface along a normal to the offset surface generated and the offset distance is less than a given or predeterminable tolerance.

To solve this problem the invention proposes a process having the features of claim 1 and a computer system having the features of claim 7. Advantageous embodiments are described in the subsidiary claims.

The invention is based on the finding that an offset surface or curve can be generated within certain tolerances using an approximation normal instead of the usual standard normal. Whereas the standard normal (“conventional” normal) is located perpendicularly to the starting curve at all points thereof, in accordance with the properties of a normal vector, the approximation normal is not always positioned perpendicularly on the starting curve but is perpendicular to an approximation of the starting curve. Thus the following applies:

C^{D}_{d}(t)=C(t)+dN_{D}(t) (2)

wherein N_{D}(t)is the approximation unit normal which may be parallel to N_{T}(t) but frequently is not, particularly when there are deflections and unevennesses in the pattern of the curve, and C^{D}_{d}(t) is the offset curve obtained by means of the approximation normal according to the invention. As a result of the invention, small deviations in the starting curve such as uneven areas and the like are disregarded and consequently one of the causes of offset curves bisecting themselves is removed. A further advantage of the invention is that the offset curve generated is smoother than the starting curve and also comprises fewer data and therefore needs less memory space. Thanks to the elimination of unevenness in the starting curve as described above the invention is particularly suitable for use with splines.

According to the invention, in order to determine the approximation normal, an approximation curve is generated the position and course of which are approximate to the position and course of the starting curve. Advantageously this approximation is obtained by smoothing the starting curve.

The approximation normal is then a perpendicular to the approximation curve whose point of intersection with the starting curve forms the point at which the associated offset point is to be formed on the offset curve. It is generated or calculated along the direction of the approximation normal starting from the point of intersection at a distance corresponding to the given offset distance. A plurality of offset points thus formed are then used to form the desired offset curve. The offset curve is formed from the plurality of offset points using interpolation methods known per se.

According to a particularly advantageous feature of the invention the starting surface is smoothed by successively fixing a pair of points on the starting surface and forming a secant extending through the pair of points, the direction of the approximation normal being provided by the perpendicular to the secant. Preferably, the perpendicular to the secant is the midperpendicular to the secant between the two points of the pair of points. This procedure according to the invention provides a very simple and quick method of smoothing the starting curve which can thus also be carried out with comparatively little working memory. Thus, identical curves can be processed in a shorter time or larger quantities of data can be processed in the same time.

The invention relates to a process and a computer system for generating a multidimensional offset surface and a computer program with program coding means which are suitable for performing the process according to the invention when the computer program is run on a computer. In particular, it claims protection for any product capable of performing a process according to the invention and in particular for a programmed translation of the invention in all its manifestations, either as a computer program supplied for downloading through the internet and stored at that moment in a server memory, or as programmed process instructions (algorithm) stored on a computer-readable medium.

Further advantages and embodiments of the invention will become apparent from the description and the accompanying drawings.

It will be understood that the features mentioned above and those to be described in more detail hereinafter can be used not only in the combination specified but in other combinations or on their own without departing from the scope of the present invention.

The invention is schematically illustrated in the drawings with reference to some embodiments by way of example and is described in detail hereinafter with reference to the drawings.

### BRIEF DESCRIPTION OF THE DRAWINGS

FIG. 1 shows a starting curve with a conventional offset shown by continuous lines and with an offset according to the invention shown by dotted lines.

FIG. 2 shows the difference between a conventional normal vector which stands perpendicular to a tangent through a given point of the starting curve, and an approximation normal vector according to the invention.

### DETAILED DESCRIPTION

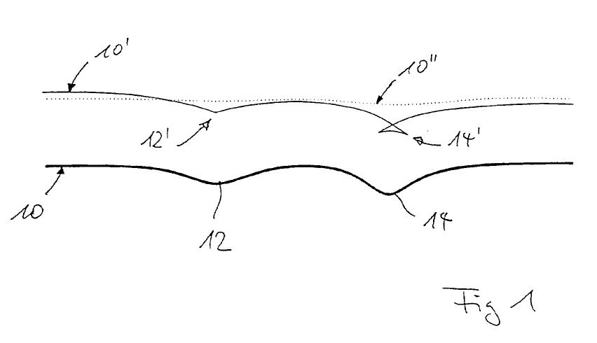

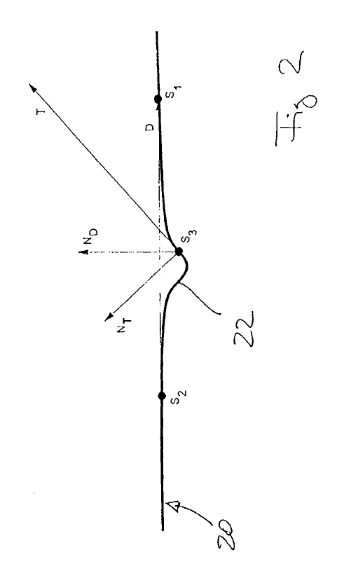

FIG. 1 shows a starting curve 10, drawn in continuous bold lines, with an associated conventional offset curve 10′, shown by a thin continuous line, and an offset curve 10″ according to the invention shown by dotted lines. As is apparent from FIG. 1, the conventional offset curve 10′ has the disadvantage that its course has some deficiencies of the kind which frequently occur in conventional offset curves the points of which are determined according to formula (1). The depression or ditch 12 in the starting curve 10 shown on the left in FIG. 1 has a kink 12′ in the course of the offset curve 10′ whereas when the offset was made from the right-hand ditch 14 in the starting curve 10 a loop 14′ which bisects itself was formed. This is unacceptable for practical applications, however, and in the past has been solved either by scanning the resulting offset curve for any such deficiencies so as to remedy them with mathematical algorithms or by using one of the approximation methods mentioned hereinbefore.

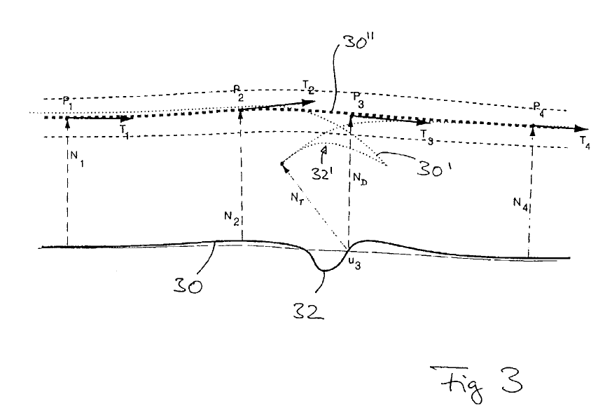

The basic mode of operation of the invention will now be described with reference to the illustration in FIG. 2.

FIG. 2 shows a starting curve 20 with a depression or ditch 22. Let us now look at the generation of the offset point associated with a point S₃ on the starting curve 20 located in the ditch.

In the conventional method, the normal vector N_{T} is determined using the tangent T to the starting curve 20 passing through the point S₃ and is thus perpendicular to the starting curve 20 at the point S₃ thereof. Because of the relatively sharp gradient of the starting curve 20 in the region of the ditch 22 the normal “tilts” to the side, thus causing the offset curve to run as illustrated in FIG. 1 with the loop 14′ bisecting itself.

This is avoided according to the invention by generating an approximation normal N_{D}. The approximation normal N_{D} is generated by means of a pair of points (S₁, S₂). This pair of points S₁, S₂ is located on the starting curve 20 and has a predetermined distance D. In the embodiment shown by way of example the two points S₁, S₂ are located equally far out on both sides of the point S₃ so that the midperpendicular to the point of connection D between the points S₁, S₂ runs through S₃. This midperpendicular constitutes the direction of the approximation normal N_{D}.

By the process according to the invention, an approximation normal is generated, by a very simple method, reproducing the general trend of the curve and smoothing out any deflections or ditches in the course of the curve so that the offset curve produced also follows the trend of the starting curve and does not have any of the deficiencies described above. The method of approximation is “set” by specifying the distance D between the points S₁ and S₂. The further apart the two points S₁ and S₂ are, the greater the smoothing effect, but the more the shape of the curve is straightened out and thus falsified. The closer the two points S₁ and S₂ migrate towards each other, the less the smoothing effect and the closer the approximation normal comes to the conventional normal N_{T}.

The invention thus provides an offset curve which reproduces the course of the starting curve at a given distance D from the starting curve within predetermined tolerances. As anyone skilled in the art will see from FIG. 2, the direction of the tangent (first derivative) T always corresponds to the direction D if it is a straight curve section and the two points S₁ and S₂ are both located on this straight curve section. If one of the two points S₁ and S₂ migrates into the ditch 22 in the starting curve, the direction of D no longer corresponds to the direction of T even though a straight curve section is inherently present. In this situation the normal is “disrupted”, i.e. there is a deviation from N_{D} to N_{T}, but compared with the abovementioned “tilting” of the normal vector N_{T} when passing through the ditch this is negligible.

FIG. 3 shows, analogously to FIG. 1, a starting curve 30 drawn with continuous bold lines, with an associated conventional offset curve 30′ shown by dotted lines and an offset curve 30″ according to the invention shown by bold dotted lines. The diagram in FIG. 3 again shows how a ditch 32 in the starting curve 30 is offset into a loop 32′ which bisects itself, by the conventional method, whereas the offset curve 30″ according to the invention has no “anomaly”.

As already described in connection with FIG. 2, using the approximation normal vector N_{D} according to the invention a point is generated on the offset curve 30″ to be generated, which is designated P₃ in FIG. 3.

Accordingly, the normals N₁, N₂ and N₄ also shown each generate points P₁, P₂ and P₄ respectively, on the offset curve 30″ which differ only slightly from the points of the conventional offset curve 30′.

According to the invention, an offset curve is generated from a variable number of points P₁, P₂, P₃, P₄, . . . , Pᵢ, by carrying out a refinement using an interpolation process. The basis for the interpolation consists of tangents T₁, T₂, T₃, T₄, . . . , Tᵢ, associated with the various points. The method of refinement thus consists in expanding an accumulation (more generally a network) of points and associated derivatives (tangents) and interpolating them in order to obtain the final offset curve (or more generally offset surface). The refinement is continued until the following three criteria have been met, namely: (i) the difference between the spacing of a point on the given starting surface along a normal to the offset surface generated and the offset distance is less than a given or predeterminable tolerance, (ii) the offset surface does not bisect itself and (iii) the offset surface generated contains as few data as possible and preferably contains fewer data and is smoother than the starting surface provided.

The invention is preferably converted using the following algorithms given in Pseudo code, some of which are recursive.

Algorithm: “RefineCurveSegment”:
begin (with a curve segment as input)

Apply Hermite interpolation and check if the
approximation is good enough.
if (not good enough)
begin
Insert new (position, tangent) where most needed
and split segment;
RefineCurveSegment (new left subsegment);
RefineCurveSegment (new right subsegment);
end;

end;
Algorithm: ‘SloppyCurveOffset’:
begin

Initialize grid with n (position, tangent) pairs.
(The two corner points (with tangents) of the
“standard offset” is one possible choice, any
other sensible initial grid can be used.)
for i = 1 step 1 until n do
begin

RefineCurveSegment (curve segment i);

end;

end;
Algorithm: ‘RefineCurve’:
begin (with a curve with n curve segments as input.)

for i = 1 step 1 until n do
begin

RefineCurveSegment (curve segment i);

end;

end;
Algorithm: ‘RefinePatch’:
begin (with a patch as input)

Apply Hermite interpolation and check if the
approximation is good enough.
if (not good enough)
begin
Insert new (position, tangent) where most needed
and split patch in the v-direction, i.e., with a
v-curve segment;
Split all other patches in the column likewise,
creating a new v-curve.
RefinePatchColumn (left new column);
RefinePatchColumn (right new column);
RefineCurve (new v-curve);
end;

end;
Algorithm: ‘RefinePatchColumn’:
begin (with a column of n patches as input)

for i = 1 step 1 until n do
begin

RefinePatch (curve segment i);

end;

end;
Algorithm: ‘SloppySurfaceOffset’:
begin

Initialise grid with n₁ × n₂ (position, tangent)
entries.
(Number of u-curves is n₂, number of v-curves is
n₁.).
(The four corner points (with tangents) of the
“standard offset” is one possible choice, any
other sensible initial grid can be used).
for i = 1 step 1 until n₁ do
begin

RefineCurve (v-curve i);

end;

(Note that n₁ is now different from what it was on
entry.)

for i = 1 step 1 until n₁ − 1 do
begin

RefinePatchColumn (v-column i);

end;

end;

1. Process for generating a multidimensional offset surface with a predeterminable distance (d) from a starting surface (10, 20) of the same dimensions, wherein in order to generate a point on the offset surface (10″) (offset point) an approximation normal (N_{D}) is determined, which stands perpendicular to an approximation surface the position and course of which correspond approximately to the position and course of the starting surface (10, 20), the approximation normal (N_{D}) forming a point of intersection (S₃) with the starting surface (10, 20) which forms the point of the starting surface (10, 20) relative to which the associated offset point is to be generated, and the offset point is generated along the direction of the approximation normal (N_{D}) starting from the point of intersection (S₃) at a distance corresponding to the given offset distance (d), while a plurality of offset points obtained in this way serve to form the offset surface (10″).

2. Process according to claim 1, wherein the approximation surface (10″) is obtained by smoothing the starting surface (10, 20).

3. Process according to claim 2, wherein the smoothing of the starting surface (10, 20) is carried out by successively fixing a pair of points (S₁, S₂) on the starting surface (10, 20) and forming a secant (D) which passes through the pair of points (S₁, S₂), the direction of the approximation normal (N_{D}) being provided by the perpendicular to the secant (D).

4. Process according to claim 3, wherein the perpendicular to the secant (D) is the midperpendicular to the secant (D) between the two points (S₁, S₂) of the pair of points.

5. Process according to claim 3 or 4, wherein the smoothing curve is generated by means of the centre points of successive secants (D).

6. Process according to claim 1, wherein the spacing of the points (S₁, S₂) from one another is variable.

7. Computer system having memory means for storing data which define a virtual model displayed on one or more monitors with at least one multidimensional surface, the minimum of one surface constituting a starting surface (10, 20) relative to which an offset surface (10″) is to be generated, with input means for inputting an offset distance (d) and with calculating means for calculating an approximation normal (N_{D}) which is located perpendicular to an approximation surface the position and course of which correspond approximately to the position and course of the starting surface (10, 20), the approximation normal (N_{D}) forming with the starting surface (10, 20) a point of intersection (S₃) which forms the point of the starting surface (10, 20) relative to which the associated offset point is to be generated, the offset point being calculated along the direction of the approximation normal (N_{D}) starting from the point of intersection (S₃) at a distance corresponding to the given offset distance (d), while a plurality of offset points calculated in this way serve to form the offset surface (10″).

8. Computer system according to claim 7, wherein the starting surface (10, 20) is smoothed in order to calculate the approximation surface.

9. Computer system according to claim 8, wherein the starting surface (10, 20) is smoothed by successively fixing a pair of points (S₁, S₂) on the starting surface (10, 20) and forming a secant (D) extending through the pair of points (S₁, S₂), the direction of the approximation normal (N_{D}) being provided by the perpendicular to the secant (D).

10. Computer system according to claim 9, wherein the perpendicular to the secant (D) is the midperpendicular to the secant (D) between the two points (S₁, S₂) of the pair of points.

11. Computer system according to claim 9 or 10, wherein the smoothing curve is generated by means of the centre points of successive secants (D).

12. Product for performing the process according to one of claims 1 to 6, the product being a computer program with program coding means which, when the computer program is run on a computer, are capable of carrying out a process according to one of claims 1 to 5.

13. Computer program according to claim 12 which is stored on a computer-readable medium.

14. Computer-readable data carrier with a computer program stored thereon which comprises program coding means which, when the computer program is run on a computer, are capable of carrying out a process according to one of claims 1 to 6.

15. Computer system having memory means in which a computer program with program coding means is stored which, when the computer program is run on a computer, are capable of carrying out a process according to one of claims 1 to 6.
